(19) United States
(12) Patent Application Publication
(10) Pub. No.: US 2019/0149934 A1
(43) Pub. Date: May 16, 2019

(54) DEVICE FOR AIRBORNE SOUND ACOUSTIC SENSING OF THE SURROUNDINGS OF A VEHICLE, VEHICLE

(71) Applicant: Robert Bosch GmbH, Stuttgart (DE)

(72) Inventors: Michael Fischer, Niefern-Oeschelbronn (DE); Hartmut Stetter, Ostfildern-Nellingen (DE); Udo Hermann, Burgstetten (DE); Stephan Berneke, Pforzheim (DE)

(21) Appl. No.: 16/191,502

(22) Filed: Nov. 15, 2018

(30) Foreign Application Priority Data
Nov. 16, 2017 (DE) 10 2017 220 474.5

(51) Int. Cl. H04R 29/00; H04R 1/04; H04R 1/08; H04R 3/00

(52) U.S. Cl. CPC H04R 29/004; H04R 3/00; H04R 1/08; H04R 1/04

(57) ABSTRACT

A device (1) for airborne sound acoustic sensing of the surroundings of a vehicle, the device (1), comprising at least one microphone (2), which is integrated in a housing (3) which, in the region of the microphone (2), has at least one opening (4) for the entry of sound waves. According to the invention, in the region of the opening (4) and at a distance from the microphone (2) there is arranged at least one film or membrane (5) which, together with the microphone (2) and the housing (3), delimits an ante-volume (6), the cross-sectional area of which increases from inside to outside in relation to the housing (3), so that a cross sectional area (A) of the ante-volume (6) adjacent to the film or membrane (5) is greater than a cross sectional area (B) of the ante-volume (6) adjacent to the microphone (2).

### BACKGROUND OF THE INVENTION

The invention relates to a device for the airborne sound acoustic sensing of the surroundings of a vehicle. The invention also relates to a vehicle having such a device.

Current vehicles are equipped with a multiplicity of assistance systems which are primarily used for the safety of the vehicle occupants and the other traffic. The assistance systems have to be supplied with information from the surroundings of the vehicle for this purpose, which means that the vehicle surroundings must be monitored.

German laid-open specification DE 102 34 611 A1 discloses a method for monitoring the surroundings of a vehicle in which surrounding noises are detected and evaluated. The surrounding noises are used as an information source for the analysis of the surrounding situation of the vehicle. During the performance of the method, use is made of a driver information system which is equipped with at least one microphone and with means for evaluating the acoustic signals detected by the microphone.

To detect surrounding noises, the microphone has to be arranged outside on the vehicle. This means that it is subjected to wind and weather and mechanical loading by high-pressure cleaners and/or stone impacts. The more exposed the position of the microphone, the greater is the danger of damage. Microphones have therefore already been proposed which, in the region of at least one sound entry opening of a housing, behind which the microphone is arranged, have a film or membrane to protect the microphone.

### SUMMARY OF THE INVENTION

The present invention is based on the object of optimizing a device of the type mentioned previously to the effect that a film or membrane arranged in the region of a sound entry opening in order to protect a microphone influences the acoustic properties as little as possible.

The device proposed for the airborne sound acoustic sensing of the surroundings of a vehicle comprises at least one microphone, which is integrated in a housing. In the region of the microphone, the housing has at least one opening for the entry of sound waves. According to the invention, in the region of the opening and at a distance from the microphone, there is arranged at least one film or membrane which, together with the microphone and the housing, delimits an ante-volume, the cross-sectional area of which increases from inside to outside in relation to the housing. This means that a cross sectional area A of the ante-volume adjacent to the film or membrane is greater than a cross sectional area B of the ante-volume adjacent to the microphone.

The proposed geometry of the ante-volume reduces undesired acoustic impairment to the microphone sensitivity effected by the film or membrane. In particular, the proposed geometry leads to a displacement of hollow space resonances to higher frequencies. The resonances are thus shifted out of the relevant frequency range. At the same time, the proposed geometry of the ante-volume permits an enlargement of the film or membrane area, which results in the damping action of the film or membrane being reduced.

The optimal geometry of the ante-volume depends here on the necessary frequency range and/or on the film or membrane used and must accordingly be matched thereto.

Preferably, the ratio of the cross-sectional area A to the cross-sectional area B is greater than 1 and less than 10. Accordingly, the ante-volume can in particular have a funnel-shaped geometry which tapers sharply toward the microphone.

Further preferably, the ante-volume is formed rotationally symmetrically, for example shaped conically or spherically. Geometries of this type can be implemented particularly simply and thus economically.

It is also proposed that the cross-sectional area A and/or the cross-sectional area B be designed circularly, elliptically, polygonally or as a polygon with rounded corners. This means that the ante-volume can also have a non-rotationally symmetrical geometry. The geometry can thus be matched optimally to the necessary frequency range and/or to the film or membrane used.

Furthermore, the cross-sectional area A and the cross-sectional area B can be shaped differently. For example, the cross-sectional area A can be elliptical and the cross-sectional area B can be circular.

Alternatively or additionally, it is proposed that the cross-sectional area A and the cross-sectional area B be arranged to be rotated and/or offset relative to each other. In this way, asymmetrical geometries of the ante-volume can be created in order, for example, to be able to capture the sound from specific directions better.

Advantageously, the film or membrane is fixed to the outside of the housing, covering the at least one opening completely. The distance of the film or membrane from the microphone is a maximum in this case, so that in addition a maximum film or membrane area is achieved. At the same time, at least part of the housing is also protected by the film or membrane. In order to optimize the protection of the housing, the latter can be covered over a large area or even completely by the film or membrane.

To fix the film or membrane to the housing, it is proposed that the film or membrane be adhesively bonded to the housing. The bonding can be implemented simply and economically. At the same time, sealing can be effected via the bonding, so that the entry of moisture via the opening into the housing or into the ante-volume is prevented.

According to a further preferred embodiment of the invention, the film or membrane is clamped in the housing, completely covering at least the one opening. For the clamping, the housing can have a peripheral ledge, on which the film or membrane rests and is held by means of a frame inserted into the housing. In this case, the film or membrane can be exchanged and replaced simply by removing the frame.

In a development of the invention, it is proposed that the microphone be spring-mounted on one side or both sides. In this way, vibration decoupling of the microphone is achieved. The spring mounting can be formed, for example, by an elastically deformable material, in particular by an elastomer or polymer foam layer. Such layers are particularly soft, so that optimal vibration decoupling is effected. Depending on the material used, sealing can be achieved at the same time, which counteracts parasitic volume expansion of the ante-volume.

A spring mounting and/or seal can additionally be formed by a separate sealing element, which rests on the microphone and/or is arranged between the microphone and the housing. If the sealing element is arranged on the side of the microphone that faces the ante-volume, a gap remaining between the microphone and the housing, which otherwise would lead to parasitic volume expansion of the ante-volume, can be sealed off.

Furthermore, the spring mounting and/or seal can be formed by an at least partial overmolding and/or by an adhesive layer. For example, the microphone can have an at least partial overmolding which is sufficiently thick that a spring mounting is achievable thereby. The at least partial overmolding of the microphone simultaneously forms a further protective layer.

Advantageously, the microphone is clamped in between two layers and/or bodies for the spring mounting. This ensures that no gap remains between the microphone and the respectively adjacent component.

The microphone can comprise a printed circuit board delimiting the ante-volume and having at least one sound entry opening, behind which a sensor element is arranged. Given an appropriate structure of the microphone, the spring mounting or seal is preferably arranged between the printed circuit board of the microphone and the housing. In order to seal off between the printed circuit board and the sensor element, it is proposed that the sensor element be connected to the printed circuit board via a solder connection. The solder connection effects an integral connection, so that at the same time sealing is created hereby.

Since the preferred area of application of the device according to the invention is a vehicle, also proposed is a vehicle having a device according to the invention for the airborne sound acoustic sensing of the surroundings. The device permits the detection of a source of danger, so that the driver of the vehicle or the vehicle itself can react thereto. The vehicle can accordingly be in particular a self-driving vehicle.

### BRIEF DESCRIPTION OF THE DRAWINGS

Preferred embodiments of the invention will be explained in more detail below by using the appended drawings, in which:

FIG. 1 shows a schematic longitudinal section through a device according to the invention according to a first preferred embodiment,

FIG. 2 shows a schematic longitudinal section through a device according to the invention according to a second preferred embodiment,

FIG. 3a) through 3f) each show a schematic longitudinal section through a device according to the invention to illustrate possible variations of the geometry of the ante-volume,

FIG. 4a) through 4f) each show a plan view of various cross-sectional pairings,

FIG. 5 shows a schematic longitudinal section through a device according to the invention according to a third preferred embodiment,

FIG. 6 shows a schematic longitudinal section through a device according to the invention according to a fourth preferred embodiment,

FIG. 7 shows a schematic longitudinal section through a device according to the invention according to a fifth preferred embodiment, and

FIG. 8 shows a schematic longitudinal section through a device according to the invention according to a sixth preferred embodiment.

### DETAILED DESCRIPTION

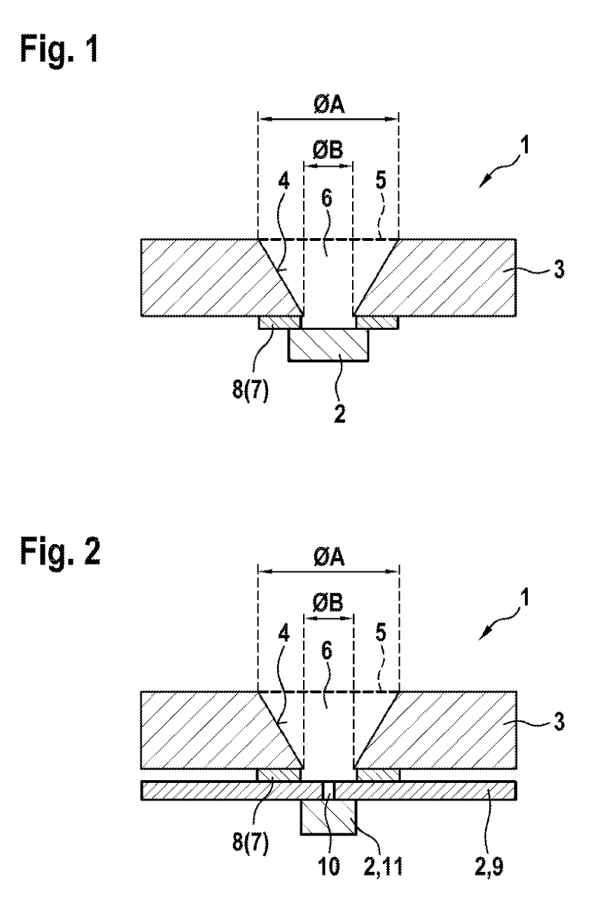

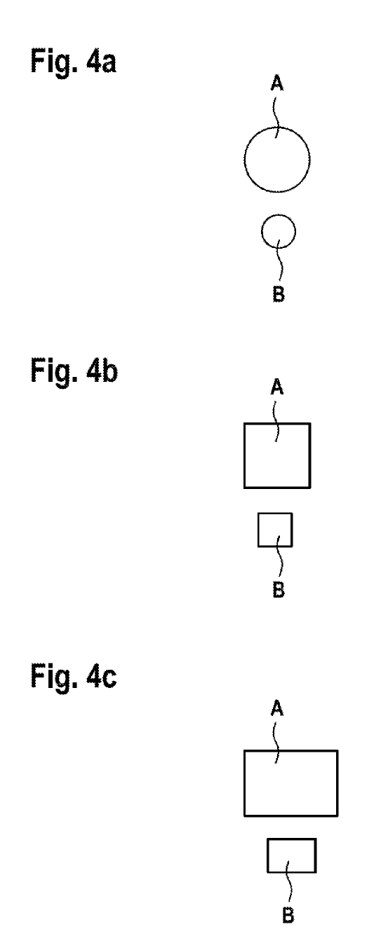

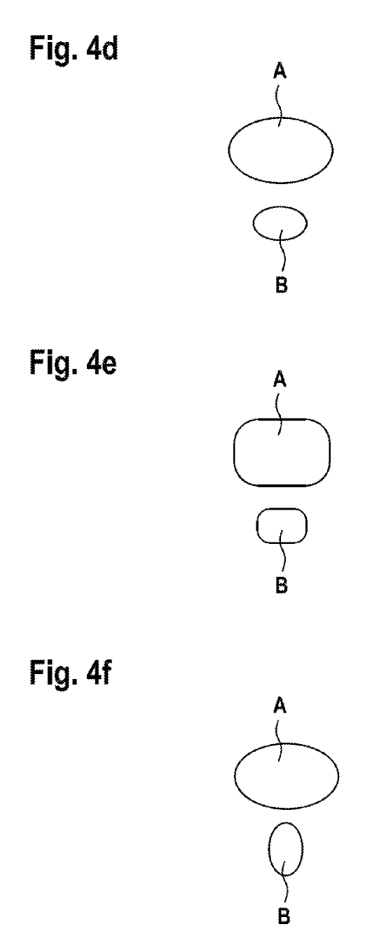

The device 1 according to the invention for the airborne sound acoustic sensing of the surroundings of a vehicle, illustrated schematically in longitudinal section in FIG. 1, comprises a microphone 2 which is inserted into a housing 3. The housing 3 has an opening 4 for the entry of sound waves. The microphone 2 is placed behind the opening 4. A membrane 5 which, together with the housing 3 and the microphone 2, encloses an ante-volume 6, extends over the opening 4. The ante-volume 6 has a cross-sectional area which becomes larger from the inside to outside. This means that a cross-sectional area A at the membrane 5 is larger than a cross-sectional area B at the microphone 2. Since, in the present case, the cross-sectional area is circular in plan view (see FIG. 4a), the diameter of the cross-sectional area A is larger than the diameter of the cross-sectional area B. The ante-volume 6 accordingly has a conically shaped geometry, which permits a large membrane area, so that the damping action of the membrane 5 is reduced. In order to avoid parasitic volume expansion via an interspace remaining free between the microphone 2 and the housing 3, a sealing element 8, which consists of an elastically deformable material, is arranged between the microphone 2 and the housing 3. In this way, via the sealing element 8, vibration decoupling of the microphone 2 with respect to the housing 3 is simultaneously effected. As a result, the sensitivity of the microphone 2 rises. Instead of the sealing element 8, an elastomer or polymer foam layer 7 can also be arranged between the microphone 2 and the housing 3.

A modification of the device 1 is illustrated in FIG. 2. Here, the microphone 2 is formed from a printed circuit board 9 and a sensor element 11, which is arranged behind a sound entry opening 10 of the printed circuit board 9 and is soldered to the printed circuit board 9. In this case, the sealing element 8 is arranged between the printed circuit board 9 and the housing 3.

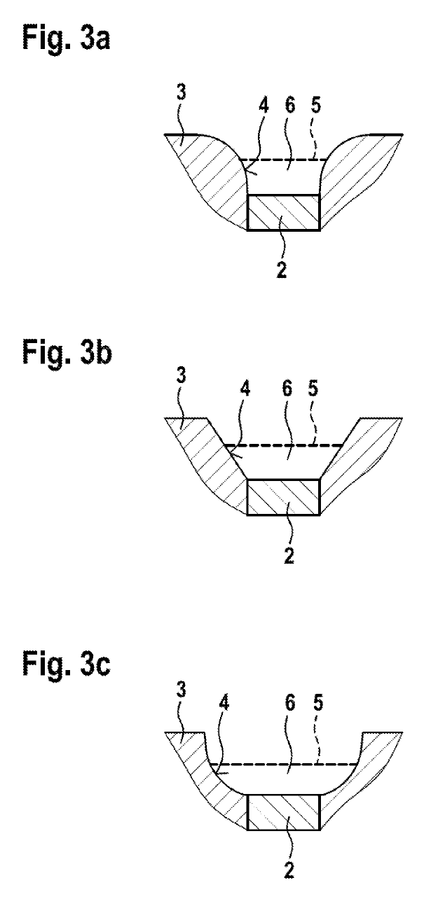

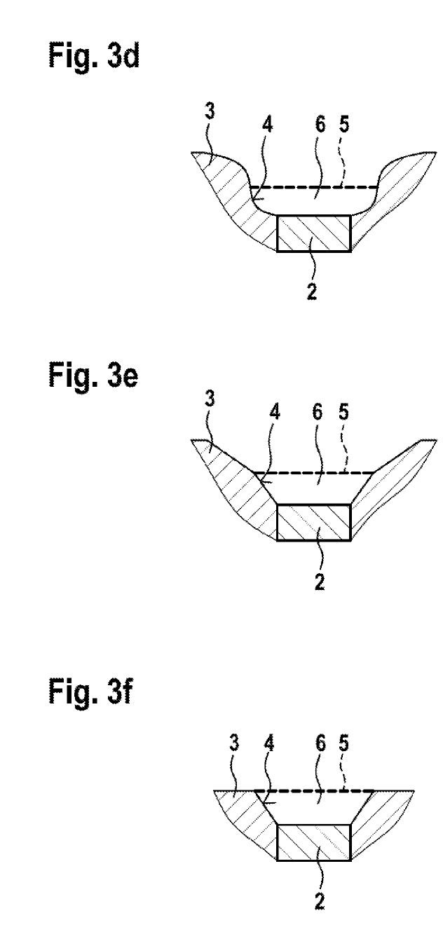

As can be gathered in particular from FIG. 3, the ante-volume 6 can have different geometries. They all have in common the fact that the cross-sectional area A is larger than the cross-sectional area B. The geometry can in particular be funnel-like, to be specific with a straight contour (see FIG. 3b, FIG. 3e and FIG. 3f) or with a curved contour (see FIG. 3a, FIG. 3c and FIG. 3d), both concave and convex curvatures being possible. Also to be gathered from FIG. 3 is that the membrane 5 can be arranged on the outside (see FIG. 3f) or within the opening 4 (see FIG. 3a to FIG. 3e).

The cross-sectional areas A and B can be arranged concentrically but do not have to be.

In addition, the cross-sectional areas A and B can have a shape deviating from the circular shape. Examples are shown in FIGS. 4b to 4f. In FIG. 4f, the cross-sectional areas A and B are arranged to be rotated relative to each other. Alternatively or additionally, the cross-sectional areas A and B can also be arranged to be offset relative to each other (not illustrated).

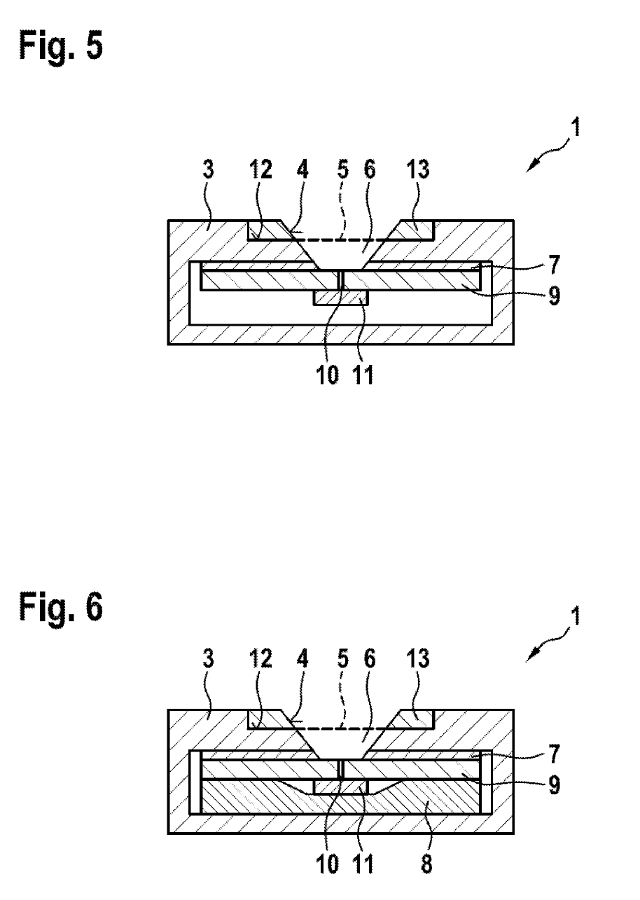

Further preferred embodiments of a device 1 according to the invention can be gathered from FIGS. 5 to 8. These differ with regard to the mounting of the microphone 2, the microphone 2 in each case comprising a printed circuit board 9 and a sensor element 11. The membrane 5 is additionally clamped in between a ledge 12 of the housing 3 and a frame 13, so that the membrane 5 in each case comes to lie within the opening 4.

In the embodiment of FIG. 5, the microphone 2 is mounted via a polymer foam layer 9, which is formed between the microphone 2 and the housing 3 and at the same time effects adhesive bonding of the microphone 2 to the housing 3. There is accordingly no direct contact between the microphone 2 and the housing 3.

In the embodiment of FIG. 6, the microphone 2 is spring-mounted on both sides, since the microphone 2 is clamped in between a polymer foam layer 7 and a sealing element 8.

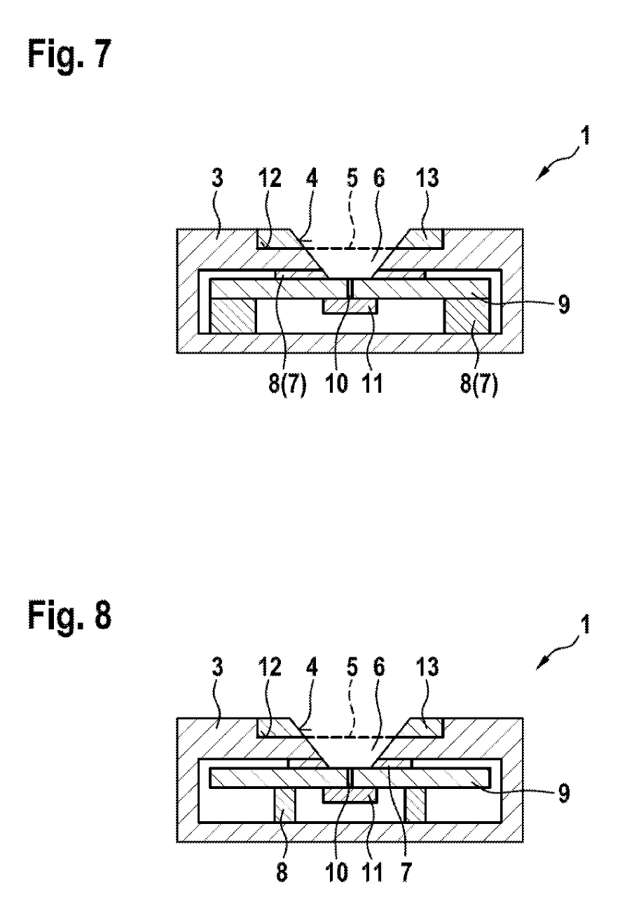

In the embodiment of FIG. 7, the microphone 2 is mounted via sealing elements 8 arranged on both sides. Alternatively, here these could also be elastomer or polymer foam layers 7 formed on both sides (see designations in brackets).

In the embodiment of FIG. 8, the microphone 2 relative to the ante-volume 6 is mounted by a polymer foam layer 7 not covering the printed circuit board 9 completely and, on the side facing away from the ante-volume 6, by small-volume sealing elements 8 which are moved inward.

The invention is not restricted to the embodiments illustrated. Rather, further embodiments are given by sub-combinations of features which cannot all be illustrated.

1. A device (1) for airborne sound acoustic sensing of the surroundings of a vehicle, the device (1) comprising at least one microphone (2), which is integrated in a housing (3) which, in a region of the microphone (2), has at least one opening (4) for the entry of sound waves, and comprising, in a region of the opening (4) and at a distance from the microphone (2), at least one film or membrane (5) which, together with the microphone (2) and the housing (3), delimits an ante-volume (6), a cross-sectional area of which increases from inside to outside in relation to the housing (3), so that a first cross-sectional area (A) of the ante-volume (6) adjacent to the film or membrane (5) is greater than a second cross-sectional area (B) of the ante-volume (6) adjacent to the microphone (2).

2. The device (1) according to claim 1, characterized in that a ratio of the first cross-sectional area (A) to the second cross-sectional area (B) is greater than 1 and less than 10.

3. The device (1) according to claim 1, characterized in that the ante-volume (6) is formed rotationally symmetrically.

4. The device (1) according to claim 1, characterized in that the first cross-sectional area (A) and/or the second cross-sectional area (B) are/is configured circularly, elliptically, polygonally or as a polygon with rounded corners.

5. The device (1) according to claim 1, characterized in that the first cross-sectional area (A) and the second cross-sectional area (B) are shaped differently.

6. The device (1) according to claim 1, characterized in that the first cross-sectional area (A) and the second cross-sectional area (B) are rotated and/or offset relative to each other.

7. The device (1) according to claim 1, characterized in that the film or membrane (5) is fixed to the outside of the housing (3), covering the at least one opening (4) completely.

8. The device (1) according to claim 1, characterized in that the film or membrane (5) is clamped in the housing (3), completely covering the at least one opening (4).

9. The device (1) according to claim 1, characterized in that the microphone (2) is spring-mounted on one side or both sides.

10. The device (1) according to claim 1, characterized in that the microphone (2) comprises a printed circuit board (9) delimiting the ante-volume (6) and having at least one sound entry opening (10), behind which a sensor element (11) is arranged.

11. A vehicle having a device (1) for airborne sound acoustic sensing of the surroundings according to claim 1.

12. The device (1) according to claim 1, characterized in that the ante-volume (6) is shaped conically or spherically.

13. The device (1) according to claim 1, characterized in that the film or membrane (5) is fixed to the outside of the housing (3), covering the at least one opening (4) completely, wherein the film or membrane (5) is adhesively bonded to the housing (3).

14. The device (1) according to claim 1, characterized in that the microphone (2) is spring-mounted on one side or both sides, wherein spring mounting is formed by an elastically deformable material.

15. The device (1) according to claim 1, characterized in that the microphone (2) is spring-mounted on one side or both sides, wherein spring mounting is formed by an elastomer or polymer foam layer (7), by an elastically deformable sealing element (8), by an at least partial overmolding and/or by an adhesive layer.

16. The device (1) according to claim 1, characterized in that the microphone (2) comprises a printed circuit board (9) delimiting the ante-volume (6) and having at least one sound entry opening (10), behind which a sensor element (11) is arranged, wherein the sensor element (11) is connected to the printed circuit board (9) via a solder connection.
